(19) United States
(12) Patent Application Publication
(10) Pub. No.: US 2024/0183332 A1
(43) Pub. Date: Jun. 6, 2024

(54) WIND TURBINE

(71) Applicant: ELMOCTAR LEMINE, CINCINNATI, OH (US)

(72) Inventor: ELMOCTAR LEMINE, CINCINNATI, OH (US)

(21) Appl. No.: 18/138,843

(22) Filed: Apr. 25, 2023

Related U.S. Application Data
(60) Provisional application No. 63/344,605, filed on May 22, 2022.

(51) Int. Cl. F03D 3/06; F03D 3/00

(52) U.S. Cl. CPC F03D 3/067; F03D 3/005; F05B 2240/218; F05B 2260/31

(57) ABSTRACT

The improved wind turbine comprises at least one rotor and a vertical shaft. The improved wind turbine may convert pressure exerted by wind blowing on the at least one rotor from any horizontal direction into rotational motion of the vertical shaft. The at least one rotor may comprise a pair of wings that may be coupled to opposing ends of a horizontal shaft such that a first wing selected from the pair of wings is vertically oriented while a second wing is horizontally oriented. The horizontal shaft may be self-pivoting such that an individual wing selected from the pair of wings is oriented vertically while travelling in a downwind direction and is oriented horizontally while travelling in an upwind direction, thus reducing drag on the individual wing traveling in the upwind direction.

### CROSS REFERENCES TO RELATED APPLICATIONS

This application claims the benefit of priority to U.S. Provisional Application No. 63/344,605, filed May 22, 2022, which is incorporated by reference herein in its entirety.

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of wind turbines, more specifically, an improve wind turbine.

### Summary of Invention

The improved wind turbine comprises at least one rotor and a vertical shaft. The improved wind turbine may convert pressure exerted by wind blowing on the at least one rotor from any horizontal direction into rotational motion of the vertical shaft. The at least one rotor may comprise a pair of wings that may be coupled to opposing ends of a horizontal shaft such that a first wing selected from the pair of wings is vertically oriented while a second wing is horizontally oriented. The horizontal shaft may be self-pivoting such that an individual wing selected from the pair of wings is oriented vertically while travelling in a downwind direction and is oriented horizontally while travelling in an upwind direction, thus reducing drag on the individual wing traveling in the upwind direction. In some embodiments, multiple rotors may be stacked to use the wind more effectively.

An object of the invention is to provide a wind turbine comprising at least one rotor and a vertical shaft that may rotate under the influence of the wind.

Another object of the invention is to provide a pair of wings coupled to opposing ends of a horizontal shaft with a first wing that is vertically-oriented and a second wing that is horizontally-oriented.

A further object of the invention is to provide a hub that is pivotably coupled to the horizontal shaft such that the horizontal shaft may pivot by 90 degrees.

Yet another object of the invention is to provide a horizontal shaft that is self-pivoting such that an individual wing selected from the pair of wings is oriented vertically while travelling in a downwind direction and is oriented horizontally while travelling in an upwind direction.

These together with additional objects, features and advantages of the improved wind turbine will be readily apparent to those of ordinary skill in the art upon reading the following detailed description of the presently preferred, but nonetheless illustrative, embodiments when taken in conjunction with the accompanying drawings.

In this respect, before explaining the current embodiments of the improved wind turbine in detail, it is to be understood that the improved wind turbine is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the improved wind turbine.

It is therefore important that the claims be regarded as including such equivalent construction insofar as they do not depart from the spirit and scope of the improved wind turbine. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is an isometric view of an embodiment of the disclosure.

FIG. 2 is a top view of an embodiment of the disclosure.

FIG. 3 is a front view of an embodiment of the disclosure, illustrating two or more rotors.

FIG. 4 is a detail view of an embodiment of the disclosure, illustrating the area designated 4 as shown in FIG. 3.

FIG. 5 is a detail view of an embodiment of the disclosure, illustrating the area designated 5 as shown in FIG. 1.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

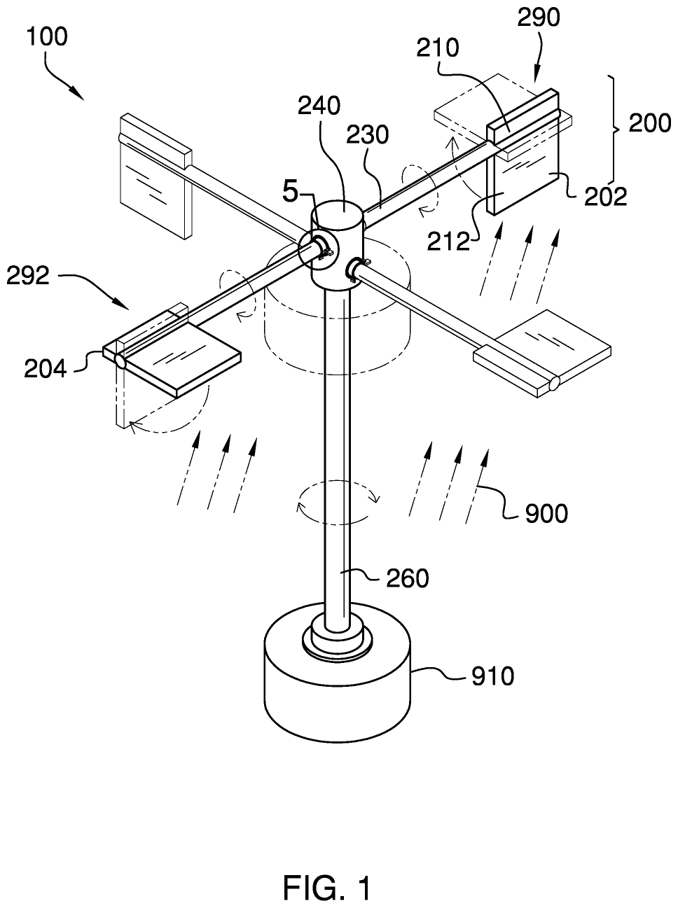

Detailed reference will now be made to a first potential embodiment of the disclosure, which is illustrated in FIG. 1 through.

The improved wind turbine 100 (hereinafter invention) comprises at least one rotor 200 and a vertical shaft 260. The invention 100 may convert pressure exerted by wind 900 blowing on the at least one rotor 200 from any horizontal direction into rotational motion of the vertical shaft 260. The at least one rotor 200 may comprise a pair of wings that may be coupled to opposing ends of a horizontal shaft 230 such that a first wing 202 selected from the pair of wings is vertically oriented while a second wing 204 is horizontally oriented. The horizontal shaft 230 may be self-pivoting such that an individual wing selected from the pair of wings is oriented vertically while travelling in a downwind direction 904 and is oriented horizontally while travelling in an upwind direction 906, thus reducing drag on the individual wing traveling in the upwind direction 906. In some embodiments, multiple rotors may be stacked to use the wind 900 more effectively.

The at least one rotor 200 may comprise the pair of wings, the horizontal shaft 230, and a hub 240. The horizontal shaft 230 may be pivotably coupled to the hub 240 with one half of the horizontal shaft 230 exposed on each side of the hub 240. The pair of wings may be coupled to the opposing ends of the horizontal shaft 230. The first wing 202 may be located on the end of the horizontal shaft 230 that is moving in the downwind direction 904 and may be oriented vertically such that the wind pushes against the first wing 202. The second wing 204 may be located on the end of the horizontal shaft 230 that is moving in the upwind direction 906 and may be oriented horizontally such that air resistance is minimized. The at least one rotor 200 may rotate within a horizontally-oriented plane, driven by the wind 900 pushing against the individual wing that is moving in the downwind direction 904.

The pair of wings may comprise the first wing 202 and the second wing 204. The individual wing selected from the pair of wings may be a vane coupled to the horizontal shaft 230. The individual wing may comprise a top surface 206 and a bottom surface 208. The top surface 206 may be the upper surface of the individual wing when the individual wing is oriented horizontally and the bottom surface 208 may be the surface opposite the top surface 206. The wind 900 may push against the top surface 206 when the individual wing is in a vertical orientation 290 and traveling in the downwind direction 904, causing the at least one rotor 200 to turn. The wind 900 may push against the bottom surface 208 when the individual wing is in the vertical orientation 290 and traveling in the upwind direction 906, causing the horizontal shaft 230 to pivot to a horizontal orientation 292.

The horizontal shaft 230 may define an upper section 210 and a lower section 212 of the individual wing. The upper section 210 may be the section of the individual wing that is above the horizontal shaft 230 when the individual wing is vertically oriented and the lower section 212 may be the section of the individual wing that is below the horizontal shaft 230 when the individual wing is vertically oriented. The individual wing may be coupled to the horizontal shaft 230 asymmetrically, with the lower section 212 comprising a larger area than the upper section 210.

The first wing 202 and the second wing 204 may be the same weight. A counterweight 220 coupled to the upper section 210 of the individual wing may place the center of mass 222 of the individual wing at the horizontal shaft 230 such that the horizontal shaft 230 may be pivoted and will remain in a pivoted orientation unless acted upon by an outside force. The center of pressure 224 of the individual wing may be located within the lower section 212 due to the larger surface area of the lower section 212.

The horizontal shaft 230 may comprise a moving stop 232. The moving stop 232 may be an armature that projects radially from the horizontal shaft 230 and limits the rotation of the horizontal shaft 230.

As the first wing 202 transitions from moving in the downwind direction 904 to moving in the upwind direction 906, the horizontal shaft 230 may rotate by 90 degrees such that the second wing 204 becomes vertically-oriented and captures the wind 900 while the first wing 202 becomes horizontally-oriented and minimizes air resistance. As the first wing 202 begins moving in the upwind direction 906, the wind 900 may push against the bottom surface 208 of the first wing 202 and may lift the first wing 202 into the horizontal orientation 292. As the first wing 202 begins pivoting into the horizontal orientation 292, the top surface 206 of the second wing 204 may become exposed to the wind 900 and the wind 900 may pivot the second wing 204 into the vertical orientation 290. As the pair of wings move from the horizontal orientation 292 to the vertical orientation 290 and from the vertical orientation 290 to the horizontal orientation 292, the horizontal shaft 230 may be rotated by the pair of wings. Thus, this repeated 90 degree pivot of the horizontal shaft 230 is initiated by the pair of wings without the need for a motor to pivot the horizontal shaft 230.

The hub 240 may hold the horizontal shaft 230 in the horizontal orientation 292 and may permit the horizontal shaft to pivot. The bottom of the hub 240 may be coupled to the vertical shaft 260 via a vertical shaft aperture 250. The hub may rotate the vertical shaft 260 as the wind 900 causes rotation of the at least one rotor 200 by pushing against the pair of wings.

The hub 240 may comprise a horizontal shaft aperture 242 that the horizontal shaft 230 may pass through. The horizontal shaft aperture 242 may comprise a bearing 244 in order to reduce rotational friction of the horizontal shaft 230 within the horizontal shaft aperture 242.

The hub 240 may comprise an upper stationary stop 246 and a lower stationary stop 248. The upper stationary stop 246 and the lower stationary stop 248 may project away from the hub 240 adjacent to the horizontal shaft 230 such that the moving stop of the horizontal shaft 230 may be confined between the upper stationary stop 246 and the lower stationary stop 248. The upper stationary stop 246 and the lower stationary stop 248 may limit rotation of the horizontal shaft 230 to a 90 degree angle such that the pair of wings may pivot only between the horizontal orientation 292 and the vertical orientation 290.

The vertical shaft 260 may be coupled to the bottom of the hub 240 and may rotate around a vertical axis as the at least one rotor 200 turns. The vertical shaft 260 may extend downward from the hub 240 to a machine 910 that may utilize the rotation of the vertical shaft 260. As a non-limiting example, the machine 910 may be a generator that may generate electricity from the wind 900.

In some embodiments, two or more rotors 270 may be stacked to capture more of the wind 900. The two or more rotors 270 may be coupled such that the two or more rotors 270 cooperatively turn the vertical shaft 260. The orientation of the horizontal shaft 230 at each layer of the two or more rotors 270 may be rotated around the hub 240 with respect to a vertical axis such that all of the wings may pivot without mechanical interference. As non-limiting examples, with a first rotor 272 at the lowest layer of a stacking, a second rotor 274 may be turned by 45 degrees from the first rotor 272, a third rotor 276 may be turned by 90 degrees from the first rotor 272, and a fourth rotor 278 may be turned by 135 degree from the first rotor 272.

In use, wind 900 may blow at the invention 100 from any horizontal direction and may cause the at least one rotor 200 to turn. The wind 900 may even change direction while the invention is operating without affecting operation. The wind 900 may push against a first wing 202 that is in the vertical orientation 290 and may move the first wing 202 in the downwind direction 904 while a second wing 204 that is moving in the upwind direction 906 is in the horizontal orientation 292 and therefore minimizing drag. As the first wing 202 transitions to moving in the upwind direction 906, the horizontal shaft 230 may rotate 90 degrees such that the first wing 202 pivots to the horizontal orientation 292 while moving in the upwind direction 906 and the second wing 204 pivots to the vertical orientation 290 while moving in the downwind direction 904. After rotation of the vertical shaft 260, the wind 900 may push against the second wing 204. Rotation of the at least one rotor 200 may turn the vertical shaft 260 which may be coupled to a machine 910. As a non-limiting example, the machine 910 may be a generator. Two or more rotors 270 may be stacked with the horizontal shafts 230 at offset angles such that more of the wind 900 may be captured by the invention 100.

### Definitions

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” may refer to top and “lower” may refer to the bottom. As a non-limiting example, the upper end of a vertical shaft is the top end of the vertical shaft.

As used in this disclosure, an “aperture” may be an opening in a surface or object. Aperture may be synonymous with hole, slit, crack, gap, slot, or opening.

As used in this disclosure, a “bearing” may be anything that holds a rotating or sliding shaft or tube. A bearing may guide a moving component, limit the motion of a moving component relative to a fixed component and/or reduce the friction between the moving component and the fixed component.

As used herein, “center of mass” may refer to the balance point of an object. At the center of mass, the weighted relative position of the mass sums to zero. A uniform force applied to the object will appear to work at the center of mass to move the object according to Newton's laws of motion without an angular acceleration.

As used herein, “center of pressure” may refer to the point where the total sum of a pressure field acts on an object.

As used herein, the words “couple”, “couples”, “coupled” or “coupling”, may refer to connecting, either directly or indirectly, and does not necessarily imply a mechanical connection.

As used herein, “downwind” and “upwind” refer to a direction relative to the wind. Downwind is the direction away from the source of the wind. Upwind is in the direction of the source of the wind.

As used in this disclosure, the term “drag” may refer to the resistance of an object to be moved through a gas or a liquid.

In this disclosure, a “generator” may refer to a device that converts rotational mechanical energy into electric energy. As used in this disclosure, “horizontal” may be a directional term that refers to a direction that is perpendicular to the local force of gravity. Unless specifically noted in this disclosure, the horizontal direction is always perpendicular to the vertical direction.

As used in this disclosure, “orientation” may refer to the positioning and/or angular alignment of a first object relative to a second object or relative to a reference position or reference direction.

As used herein, the word “pivot” may include any mechanical arrangement that allows for rotational motion. Non-limiting examples of pivots may include hinges, holes, posts, dowels, pins, points, rods, shafts, balls, and sockets, either individually or in combination.

As used in this disclosure, “vertical” may refer to a direction that is parallel to the local force of gravity. Unless specifically noted in this disclosure, the vertical direction is always perpendicular to horizontal.

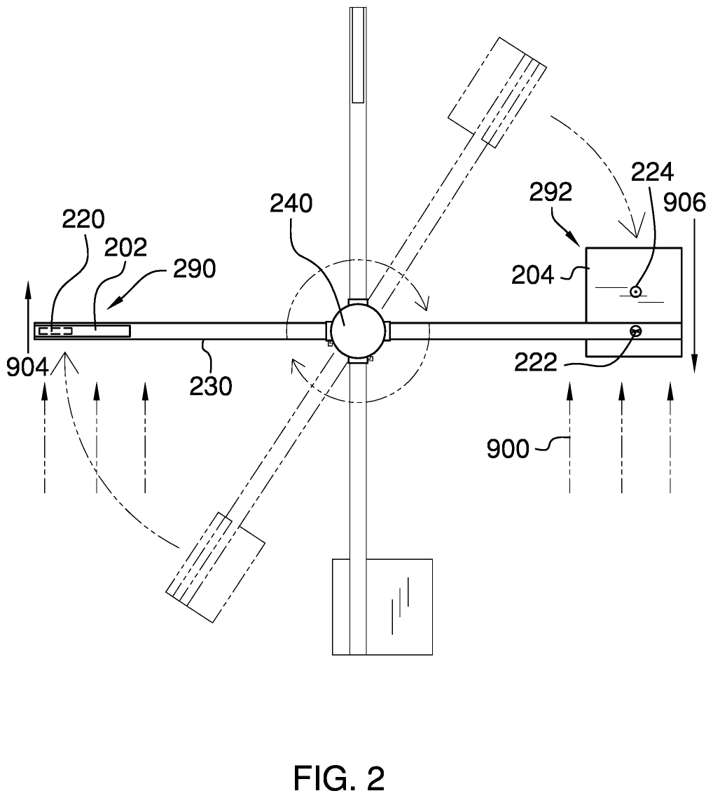

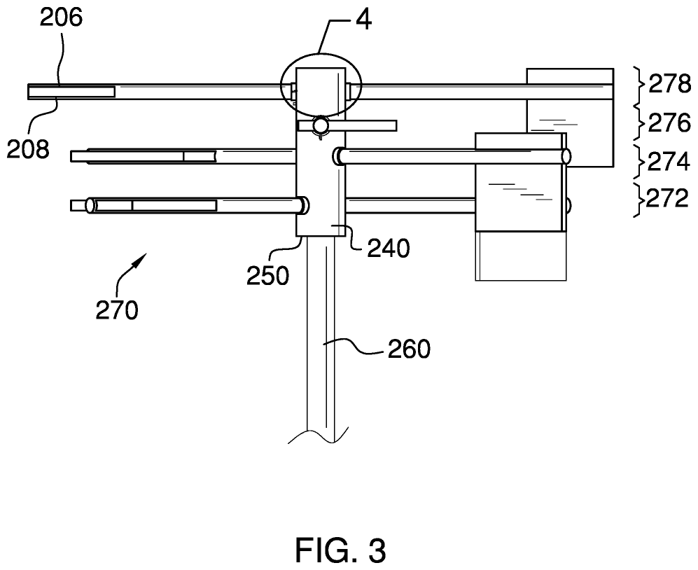

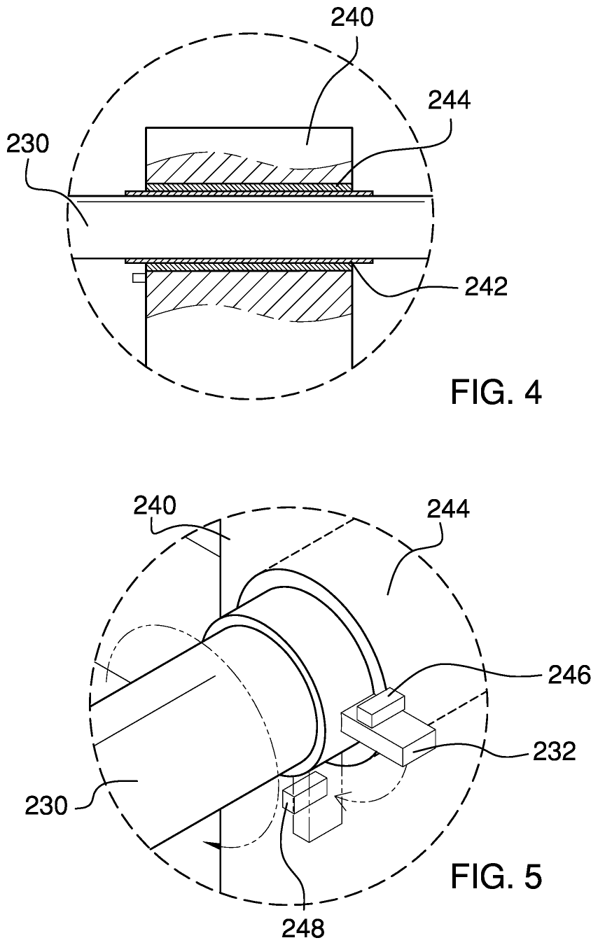

With respect to the above description, it is to be realized that the optimum dimensional relationship for the various components of the invention described above and in FIGS. 1 through 5, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. An improved wind turbine comprising:
at least one rotor and a vertical shaft;
wherein the improved wind turbine converts pressure exerted by wind blowing on the at least one rotor from any horizontal direction into rotational motion of the vertical shaft;
wherein the at least one rotor comprises a pair of wings that are coupled to opposing ends of a horizontal shaft such that a first wing selected from the pair of wings is vertically oriented while a second wing is horizontally oriented;
wherein the horizontal shaft is self-pivoting such that an individual wing selected from the pair of wings is oriented vertically while travelling in a downwind direction and is oriented horizontally while travelling in an upwind direction, thus reducing drag on the individual wing traveling in the upwind direction.

2. The improved wind turbine according to claim 1
wherein the at least one rotor comprises the pair of wings, the horizontal shaft, and a hub;
wherein the horizontal shaft is pivotably coupled to the hub with one half of the horizontal shaft exposed on each side of the hub;
wherein the pair of wings are coupled to the opposing ends of the horizontal shaft.

3. The improved wind turbine according to claim 2
wherein the first wing is located on the end of the horizontal shaft that is moving in the downwind direction and is oriented vertically such that the wind pushes against the first wing;
wherein the second wing is located on the end of the horizontal shaft that is moving in the upwind direction and is oriented horizontally such that air resistance is minimized.

4. The improved wind turbine according to claim 3
wherein the at least one rotor rotates within a horizontally-oriented plane, driven by the wind pushing against the individual wing that is moving in the downwind direction.

5. The improved wind turbine according to claim 4
wherein the pair of wings comprises the first wing and the second wing;
wherein the individual wing selected from the pair of wings is a vane coupled to the horizontal shaft.

6. The improved wind turbine according to claim 5
wherein the individual wing comprises a top surface and a bottom surface;
wherein the top surface is the upper surface of the individual wing when the individual wing is oriented horizontally and the bottom surface is the surface opposite the top surface;
wherein the wind pushes against the top surface when the individual wing is in a vertical orientation and traveling in the downwind direction, causing the at least one rotor to turn;
wherein the wind pushes against the bottom surface when the individual wing is in the vertical orientation and traveling in the upwind direction, causing the horizontal shaft to pivot to a horizontal orientation.

7. The improved wind turbine according to claim 6
wherein the horizontal shaft defines an upper section and a lower section of the individual wing;
wherein the upper section is the section of the individual wing that is above the horizontal shaft when the individual wing is vertically oriented and the lower section is the section of the individual wing that is below the horizontal shaft when the individual wing is vertically oriented;
wherein the individual wing is coupled to the horizontal shaft asymmetrically, with the lower section comprising a larger area than the upper section.

8. The improved wind turbine according to claim 7 wherein the first wing and the second wing are the same weight.

9. The improved wind turbine according to claim 7
wherein a counterweight coupled to the upper section of the individual wing places the center of mass of the individual wing at the horizontal shaft such that the horizontal shaft will remain in a pivoted orientation unless acted upon by an outside force;
wherein the center of pressure of the individual wing is located within the lower section due to the larger surface area of the lower section.

10. The improved wind turbine according to claim 9
wherein the horizontal shaft comprises a moving stop;
wherein the moving stop is an armature that projects radially from the horizontal shaft and limits the rotation of the horizontal shaft.

11. The improved wind turbine according to claim 10
wherein as the first wing transitions from moving in the downwind direction to moving in the upwind direction, the horizontal shaft rotates by 90 degrees such that the second wing becomes vertically-oriented and captures the wind while the first wing becomes horizontally-oriented and minimizes air resistance.

12. The improved wind turbine according to claim 11
wherein as the first wing begins moving in the upwind direction, the wind pushes against the bottom surface of the first wing and lifts the first wing into the horizontal orientation;
wherein as the first wing begins pivoting into the horizontal orientation, the top surface of the second wing becomes exposed to the wind and the wind pivots the second wing into the vertical orientation;
wherein as the pair of wings move from the horizontal orientation to the vertical orientation and from the vertical orientation to the horizontal orientation, the horizontal shaft is rotated by the pair of wings.

13. The improved wind turbine according to claim 12
wherein the hub holds the horizontal shaft in the horizontal orientation and permits the horizontal shaft to pivot;
wherein the bottom of the hub is coupled to the vertical shaft via a vertical shaft aperture;
wherein the hub rotates the vertical shaft as the wind causes rotation of the at least one rotor by pushing against the pair of wings.

14. The improved wind turbine according to claim 13
wherein the hub comprises a horizontal shaft aperture that the horizontal shaft passes through;
wherein the horizontal shaft aperture comprises a bearing in order to reduce rotational friction of the horizontal shaft within the horizontal shaft aperture.

15. The improved wind turbine according to claim 14
wherein the hub comprises an upper stationary stop and a lower stationary stop;
wherein the upper stationary stop and the lower stationary stop project away from the hub adjacent to the horizontal shaft such that the moving stop of the horizontal shaft is confined between the upper stationary stop and the lower stationary stop;
wherein the upper stationary stop and the lower stationary stop limit rotation of the horizontal shaft to a 90 degree angle such that the pair of wings pivot only between the horizontal orientation and the vertical orientation.

16. The improved wind turbine according to claim 15
wherein the vertical shaft is coupled to the bottom of the hub and rotates around a vertical axis as the at least one rotor turns;
wherein the vertical shaft extends downward from the hub to a machine that utilizes the rotation of the vertical shaft.

17. The improved wind turbine according to claim 16 wherein the machine is a generator that generates electricity.

18. The improved wind turbine according to claim 16
wherein two or more rotors are stacked to capture more of the wind;
wherein the two or more rotors are coupled such that the two or more rotors cooperatively turn the vertical shaft;
wherein the orientation of the horizontal shaft at each layer of the two or more rotors is rotated around the hub with respect to a vertical axis such that all of the wings pivot without mechanical interference.

19. The improved wind turbine according to claim 18
wherein with a first rotor at the lowest layer of stacked layers of rotors, a second rotor is turned by 45 degrees from the first rotor, a third rotor is turned by 90 degrees from the first rotor, and a fourth rotor is turned by 135 degree from the first rotor.
